(19) United States
(12) Patent Application Publication
(10) Pub. No.: US 2007/0199199 A1
(43) Pub. Date: Aug. 30, 2007

(54) Magnetic wand for easy wine or beer racking

(76) Inventors: Frank Michael Lake, St. John's (CA); Paul Frederick Murphy, St. John's (CA); Cyril Bruce Strong, St. John's (CA)

Correspondence Address: Frank M. Lake, 35 New Cove Road, St. John's, A1A 2B9, CA

(21) Appl. No.: 11/327,979

(22) Filed: Mar. 23, 2006

(30) Foreign Application Priority Data
Jan. 20, 2005 (CA) 2,493,937

(51) Int. Cl. B26B 3/00

(52) U.S. Cl. 30/300

(57) ABSTRACT

A modification to the home alcoholic beverage (wine or beer) production process whereby the siphoning or “racking” wand is angled at the base to bring it in contact with the container wall where it is held firmly in place by the use of magnets as shown in the attached drawings. The beverage may then be racked with little or no sediment disturbance.

This invention relates to an improvement in the process by which home wine (or beer) makers may transfer their product from one container or “fermentor” (most commonly a glass or plastic 23 L carboy) to another during various stages of the brewing process.

Home wine making is a popular and growing hobby by which anybody may, for an initial outlay of $100.00 or so, produce many quality wines at home for a cost of less than $1.00 a bottle. If the home wine maker uses bought or grown fruits and vegetables the process will take at least several months to the bottle but the process may be shortened and simplified somewhat by the use of “kit” wines.

In either case, live yeast anaerobically convert (ferment) sugars into alcohol and carbon dioxide (CO₂). During the fermentation, dead yeast cells and fruit pulp will tend to accumulate and settle to the bottom of the fermentor and will, if the wine is left in contact for an extended period of time, impart an off-flavour to the wine. Towards the end of the fermentation process, which may take weeks or months, depending on a number of conditions, every trace of sediment must be removed such that the wine may be crystal clear when bottled.

Therefore, two to four times during the production of any batch of wine, the wine must be transferred or “racked” from one fermentor to another. Since the sediment in the fermentor is very easily disturbed, the wine must be carefully siphoned by use of a plastic hose attached to a “wand” inserted in the wine. As it is desirable to transfer as much wine as possible, then the wand must be inserted in the wine as close to the sediment as possible. In fact, most wands nowadays have a small attachment on the end which helps to prevent some sediment from being drawn off with the wine.

Until now, this racking process was apt to require two persons, with varying degrees of success since it is very difficult to keep the siphoning wand steady when it is inserted to the bottom of the fermentor, more especially so if the wine is dark in colour such that the wand is not visible.

In this invention, a magnet is attached to a modified siphoning wand (FIG. 1) and another to an appropriate area on the fermentor from which the wine is being siphoned. In this way, the wand may be lowered into the wine and “locked” into place, thus turning a haphazard, two person operation into an easy, one person operation with less sediment disturbance.

Note that current wands are usually straight the whole length inserted into the wine and our process will require new wands to be angled towards the bottom in order to bring the wand into contact with the inside of the fermentor wall such that the magnets may “lock” together as in FIG. 3. Older, straight wands may be accommodated by means of slip on, adjustable ring and extension in order to bring the magnet in proximity to the wall as in FIG. 2. On the outside of the fermentor, the complementary magnet may be attached by means of glue, velcro or tape for older models or, on newer fermentors, an outside slot may be included in the production process such that the outside magnet will not slip. In this latter case, an inside non-slip lip (FIG. 3) may also be included in the fermentor production to further secure the wand magnet.

### DESCRIPTION OF ATTACHED DRAWINGS

FIG. 1: The wine racking process

FIG. 1 illustrates how wine is siphoned or “racked” from one 23 L (6 US gal.) carboy to another by means of a siphoning hose and plastic wand such that the wine is removed but the unwanted yeast sediment is left behind in the carboy. As the wand is normally hand-held outside the carboy, it is subject to movement and thus will disturb the yeast sediment which is subsequently withdrawn with the wine. This invention prevents this sediment withdrawal by holding the siphoning wand tightly against the inner wall of the carboy by means of two magnets.

FIG. 2: Adjustable magnetic improvement for current equipment showing the circled area of FIG. 1.

The wall of the carboy is shown with one magnet attached to the outside of the carboy and another magnet attached to the lower part of the siphoning wand as inserted into the carboy. The wand magnet is attached by means of an adjustable slip ring constructed of stainless steel or plastic while the outside magnet is attached to the carboy by means of glue, velcro or tape. When the two magnets are brought into close proximity with one another, the wand is held firmly such that it does not disturb the yeast sediment during racking.

FIG. 3: Permanent magnetic improvement for new equipment showing the circled area of FIG. 1.

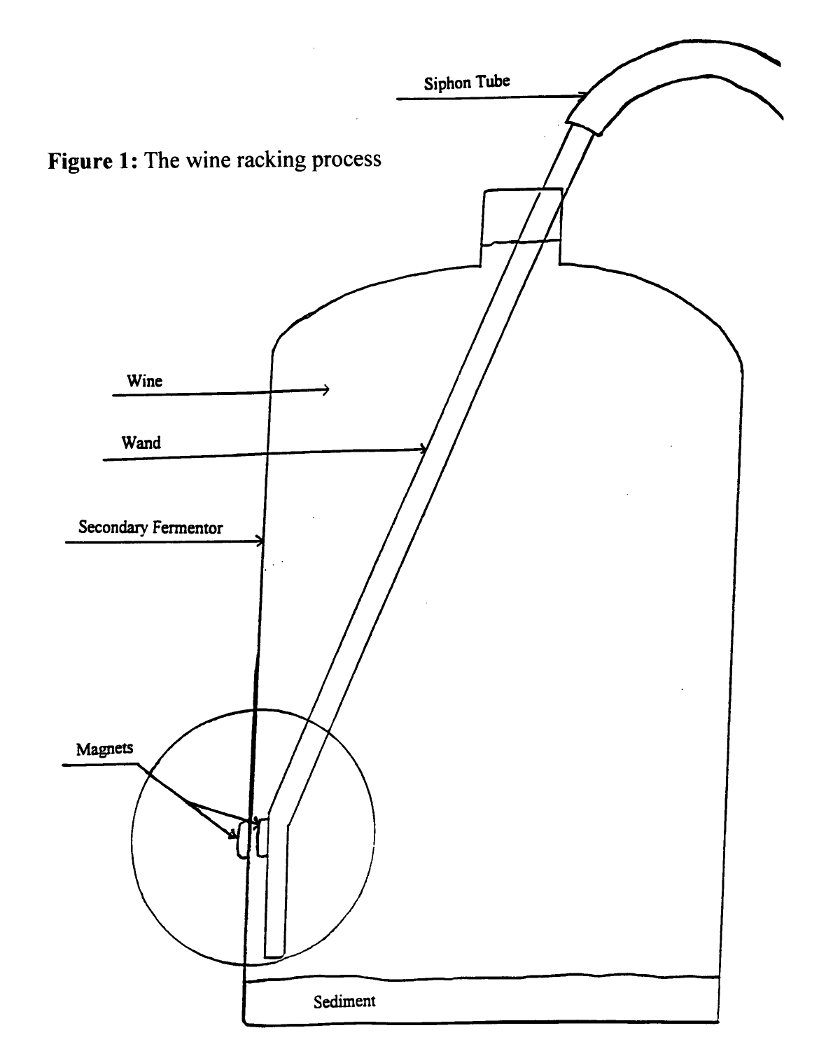

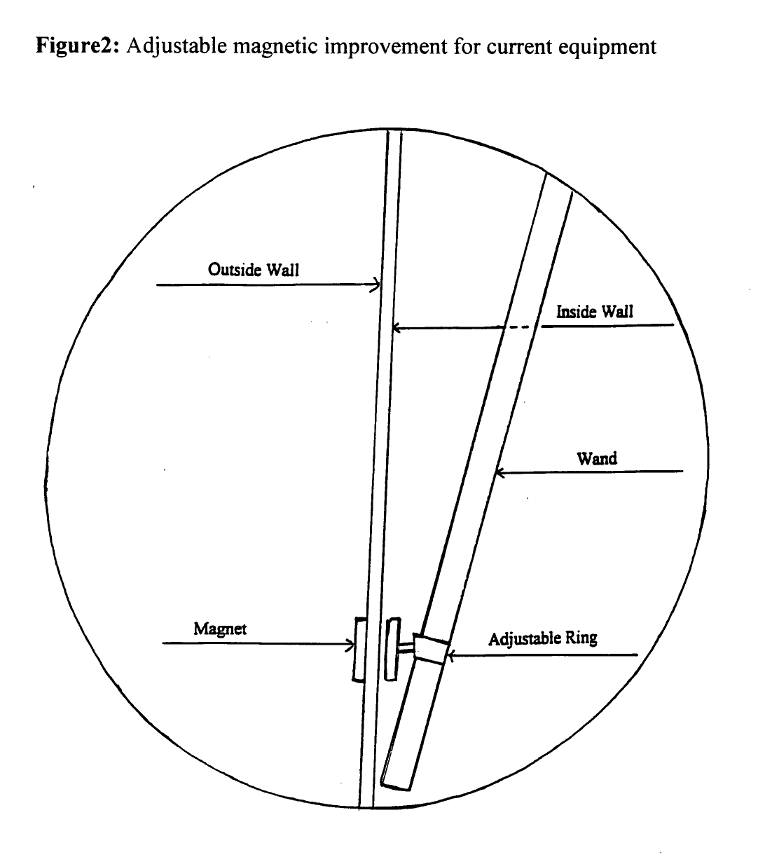

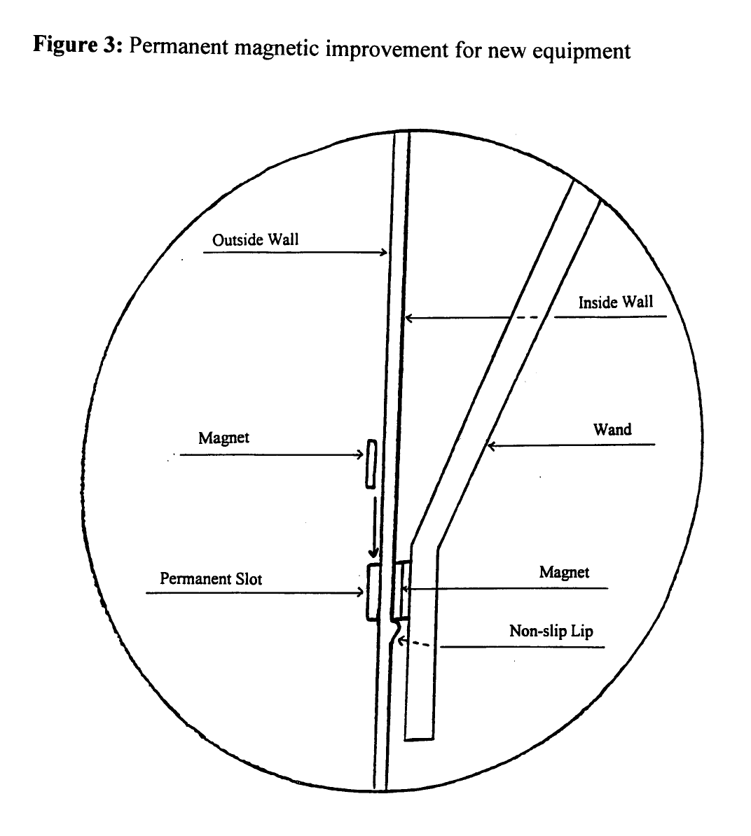

The wall of the carboy is shown with one magnet attached to the outside of the carboy and another magnet attached to the lower part of the siphoning wand as inserted into the carboy. With new production equipment, the wand may be angled somewhat near the bottom so that the wand magnet is brought closer to the wall of the carboy. The wand magnet is now molded into the production of the wand and thus need not have an adjustable slip ring as shown in FIG. 2. The carboy magnet on new production carboys will fit into a slot molded into the carboy such that glue, velcro or tape is unnecessary. These new carboys may also have a non-slip lip near the bottom on the inside such that the wand magnet will be further secured.

The embodiments of the invention in which an exclusive property or privilege is claimed are defined as follows:

1. A manually operable tool for racking wine/beer comprising of a wand angled such that it comes in contact with the walls of the fermentor such that it may be locked in place by means of appropriately attached magnets on the wand and fermentor.

2. A tool as defined in claim 1 which has one magnet attached to the fermentor and one magnet attached to the racking wand.

3. A tool as defined in claims 1 and 2 which has a fermentor magnet mounted in a secure slot and a wand magnet supported by a non-slip lip or ridge on the inside of the fermentor wall.
